(19) United States
(12) Patent Application Publication
(10) Pub. No.: US 2015/0181167 A1
(43) Pub. Date: Jun. 25, 2015

(54) ELECTRONIC DEVICE AND METHOD FOR VIDEO CONFERENCE MANAGEMENT

(71) Applicant: HON HAI PRECISION INDUSTRY CO., LTD., New Taipei (TW)

(72) Inventors: MING-CHUAN KAO, New Taipei (TW); JEN-HSIUNG CHARNG, New Taipei (TW)

(21) Appl. No.: 14/559,411

(22) Filed: Dec. 3, 2014

(30) Foreign Application Priority Data
Dec. 23, 2013 (CN) 201310717035.2

(51) Int. Cl. H04N 7/15; H04N 5/232; H04N 7/14; H04L 29/06; H04L 29/08

(52) U.S. Cl. CPC H04N 7/152; H04L 65/403; H04L 67/10; H04N 7/148; H04N 5/23232

(57) ABSTRACT

A method of managing video conference includes requesting the server for each IP address of each of the remote electronic devices. The server transmits an IP address of each of the remote electronic devices to a local electronic device. According to the received IP addresses, connections are established between the local electronic device and each of the remote electronic devices. An image of a user of the local electronic device is acquired. Images of remote users of the remote electronic devices sent by the remote electronic devices are received. The acquired image and the received images are merged into a first image for a user of the local electronic device and a second image for the remote users of the remote electronic devices. The second image is transmitted to the remote electronic devices.

### CROSS-REFERENCE TO RELATED APPLICATIONS

This application claims priority to Chinese Patent Application No. 201310717035.2 filed on Dec. 23, 2013, the contents of which are incorporated by reference herein.

### FIELD

Embodiments of the present disclosure relate to video conference technology, and particularly to video conference management using an electronic device.

### BACKGROUND

A server connected to a plurality of electronic devices can be used to implement a video conference. The server may acquire images from the electronic devices and merge the acquired images into one image. Then the server can transmit the merged image to each of the electronic devices. An image resolution for a conference chairman can be the same image resolution for other participants.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of a local electronic device including an management system.

FIG. 2 is a diagrammatic view of one embodiment of function modules of the management system in the local electronic device of FIG. 1.

FIG. 3 illustrate a flowchart of one embodiment of a method for managing video conference in the local electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

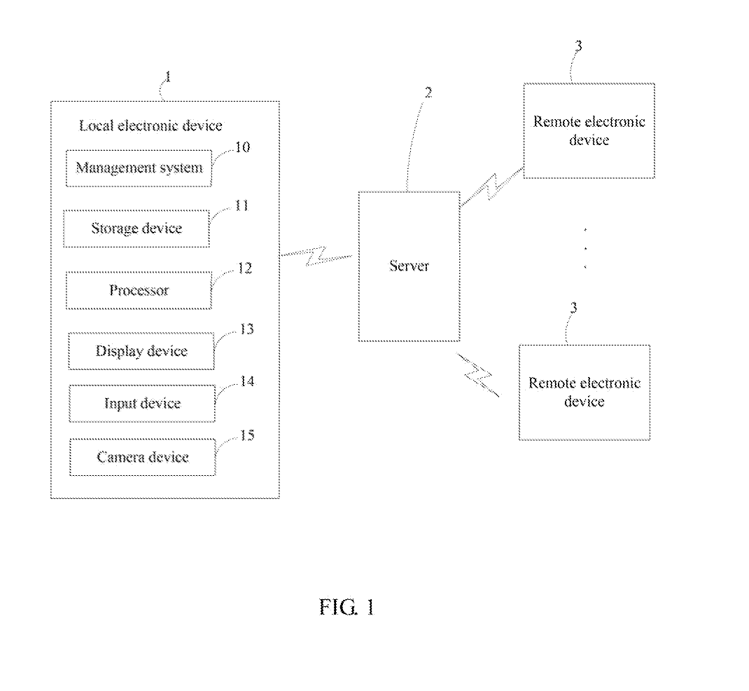

FIG. 1 illustrates a diagrammatic view of one embodiment of a local electronic device. Depending on the embodiment, a local electronic device 1 includes, but is not limited to, a management system 10, a storage device 11, at least one processor 12, a display device 13, an input device 14 and a camera device 15. The local electronic device 1 can be a computer, a smart phone, a personal digital assistant (PDA), or another suitable electronic device. FIG. 1 illustrates only one example of the electronic device that can include more or fewer components than illustrated, or have a different configuration of the various components in other embodiments.

The local electronic device 1 is connected to a server 2. The server 2 is connected to a plurality of remote electronic devices 3. In at least one embodiment, a user of the local electronic device 1 is a conference chairman, and remote users of the remote electronic devices 3 are conference participants. The server 2 stores an Internet Protocol (IP) address of the local electronic device 1 and each of the remote electronic devices 3. The remote electronic devices 3 can be computers, smart phones, personal digital assistants (PDAs), or another suitable electronic devices.

The management system 10 can establish connections between the local electronic device 1 and each of the remote electronic devices 3. Each of the remote electronic devices 3 can transmit an images of a remote user of each of the remote electronic devices to the local electronic device 1. The management system 10 can receive the images. According to the received images, the management system 10 generates a merged image for a user of the local electronic device and generates another merged image for the remote users of the remote electronic devices.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The display device 13 can display images and videos, and the input device 14 can be a mouse, a keyboard, or a touch panel.

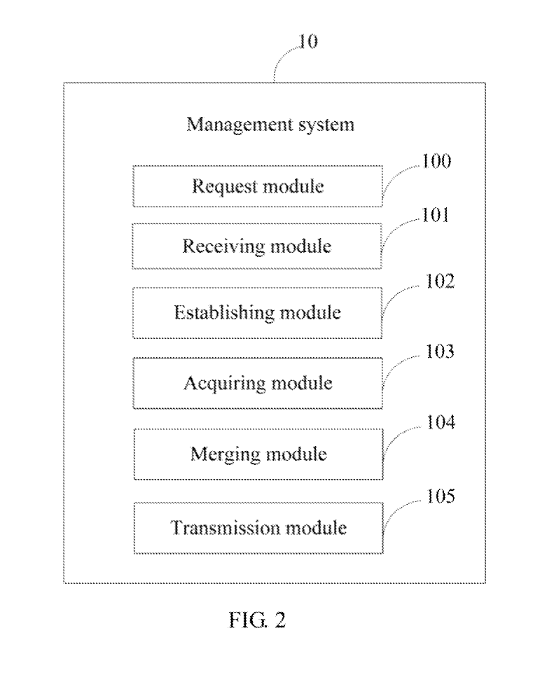

FIG. 2 is a diagrammatic view of one embodiment of function modules of the management system. In at least one embodiment, the management system 10 can include a request module 100, a receiving module 101, an establishing module 102, an acquiring module 103, a merging module 104 and a transmission module 105. The function modules 100, 101, 102, 103, 104 and 105 can include computerized codes in the form of one or more programs, which are stored in the storage device 11. The at least one processor 12 executes the computerized codes to provide functions of the function modules 100-105.

When the user of the local electronic device 1 logins in the management system 10, the request module 100 requests the server 2 for an Internet Protocol (IP) address of each of the remote electronic devices 3.

The server 2 transmits the IP address of each of the remote electronic devices 3 to the local electronic device 1. The receiving module 101 receives the IP address of each of the remote electronic devices 3. In at least one embodiment, the local electronic device 1 can identify each of the remote electronic devices 3 according to the received IP address of each of the remote electronic devices 3.

The establishing module 102 establishes connections between the local electronic device 1 and each of the remote electronic devices 3 according to the received IP address of each of the remote electronic devices 3.

In at least one embodiment, the establishing module 102 establishes the connections via a Voice over Internet Protocol (VoIP). When the establishing module 102 establishes the connections successfully, the local electronic device 1 can directly communicate with each of the remote electronic devices 3. When the establishing module 102 fails to establish the connections, the establishing module 102 re-establishes the connections.

The camera device 15 of the local electronic device 1 captures an image of a user of the local electronic device 1. The acquiring module 103 acquires the image from the camera device 15.

Camera devices of the remote electronic devices 3 capture images of remote users. The remote electronic devices 3 acquire the images of the remote users and transmit the images of the remote users to the local electronic device 1. The receiving module 101 receives the images of the remote users from the remote electronic devices 3.

The merging module 104 merges the acquired image and the received images into a first image for the user of the local electronic device 1 and merges the acquired image and the received images into a second image for the remote users of the remote electronic devices 3. A resolution of the first image is more than a resolution of the second image.

In at least one embodiment, the merging module 104 determines a number of the acquired image and the received images. The merging module 104 further determines resolutions of the acquired image and the received images, and determines a maximum resolution among the determined resolutions. According to the determined number and the maximum resolution, the merging module 104 creates a first two-dimensional array. Each element of the first two-dimensional array can store an image having the maximum resolution. The merging module 104 stores the acquired image and the received images in the first two-dimensional array. The acquired image and each of the received images is stored as an element of the first two-dimensional array. The merging module 104 displays the first two-dimensional array as the first image for the user of the local electronic device 1.

In at least one embodiment, the merging module 104 sets a specified resolution according to the determined resolutions. The specified resolution is less than the maximum resolution. According to the determined number and the specified resolution, the merging module 104 creates a second two-dimensional array. Each element of the second two-dimensional array can store an image having the specified resolution. The merging module 104 compresses the acquired image into a compressed acquired image having the specified resolution and compresses each of the received images into a compressed received image having the specified resolution. The merging module 104 stores the compressed acquired image and the compressed received images in the second two-dimensional array. The compressed acquired image and each of the compressed received images is stored as an element of the second two-dimensional array. The merging module 104 displays the second two-dimensional array as the second image for the remote users of the remote electronic devices 3.

The transmission module 105 transmits the second image to the remote electronic devices.

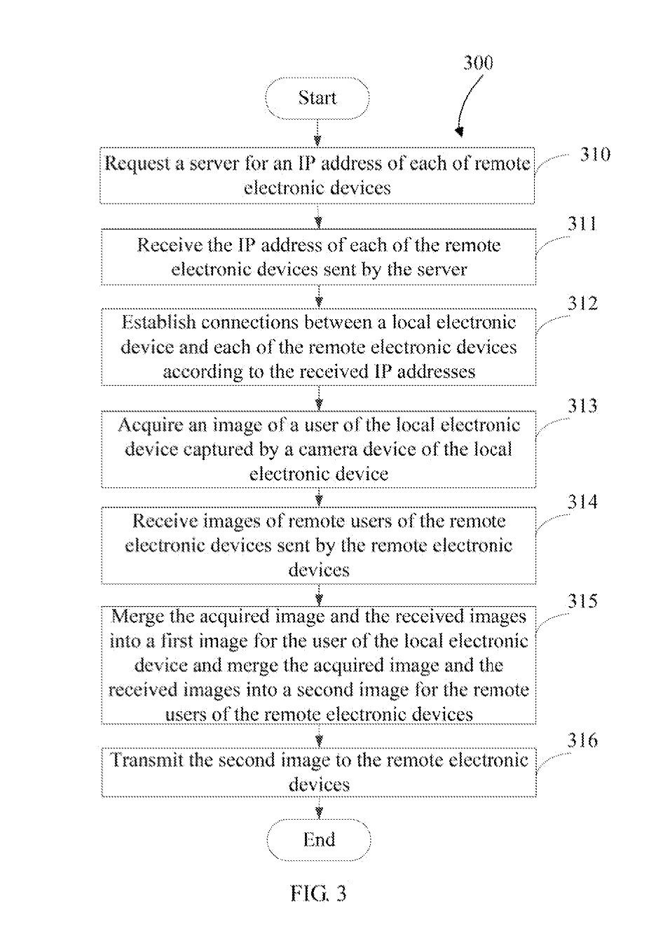

FIG. 3 illustrates a flowchart is presented in accordance with an example embodiment. The example method 300 is provided by way of example, as there are a variety of ways to carry out the method. The method 300 described below can be carried out using the configurations illustrated in FIGS. 1 and 2 for example, and various elements of these figures are referenced in explaining example method 300. Each block shown in FIG. 3 represents one or more processes, methods, or subroutines carried out in the exemplary method 300. Additionally, the illustrated order of blocks is by example only and the order of the blocks can be changed. The exemplary method 300 can begin at block 301. Depending on the embodiment, additional steps can be added, others removed, and the ordering of the steps can be changed.

At block 310, when a user of a local electronic device logins in a management system, a request module request a server for an Internet Protocol (IP) address of each of the remote electronic devices. The local electronic device is connected to the server. The server is connected to remote electronic devices. The server stores an Internet Protocol (IP) address of the local electronic device and each of the remote electronic device.

At block 311, the server transmits the IP address of each of the remote electronic devices to the local electronic device. A receiving module receives each IP address of each of the remote electronic devices. In at least one embodiment, the local electronic device can identify each of the remote electronic devices according to the received the IP addresses.

At block 312, an establishing module establishes connections between the local electronic device and each of the remote electronic devices according to the received IP addresses.

In at least one embodiment, the establishing module establishes the connections via a Voice over Internet Protocol (VoIP). When the establishing module establishes the connections successfully, the local electronic device can directly communicate with each of the remote electronic devices. When the establishing module fails to establish connections, the establishing module re-establishes the connections.

At block 313, a camera device of the local electronic device captures an image of a user of the local electronic device. An acquiring module acquires the image from the camera device.

At block 314, camera devices of the remote electronic devices capture images of remote users. The remote electronic devices acquire the images of the remote users and transmit the images of remote users to the local electronic device. The receiving module receives the images of the remote users from the remote electronic devices.

At block 315, a merging module merges the acquired image and the received images into a first image for the user of the local electronic device and merges the acquired image and the received images into a second image for the remote users of the remote electronic devices. A resolution of the first image is more than a resolution of the second image.

In at least one embodiment, the merging module determines a number of the acquired image and the received images. The merging module further determines resolutions of the acquired image and the received images, and determines a maximum resolution among the determined resolutions. According to the determined number and the maximum resolution, the merging module creates a first two-dimensional array. Each element of the first two-dimensional array can store an image having the maximum resolution. The merging module stores the acquired image and the received images in the first two-dimensional array. The acquired image and each of the received images is stored as an element of the first two-dimensional array. The merging module displays the first two-dimensional array as the first image for the user of the local electronic device.

In at least one embodiment, the merging module sets a specified resolution according to the determined resolutions. The specified resolution is less than the maximum resolution. According to the determined number and the specified resolution, the merging module creates a second two-dimensional array. Each element of the second two-dimensional array can store an image having the specified resolution. The merging module compresses the acquired image into a compressed acquired image having the specified resolution and compresses each of the received images image into a compressed received image having the specified resolution. The merging module stores the compressed acquired image and the compressed received images in the second two-dimensional array. The compressed acquired image and each of the compressed received images is stored as an element of the second two-dimensional array. The merging module displays the second two-dimensional array as the second image for the remote users of the remote electronic devices.

At block 316, a transmission module transmits the second image to the remote electronic devices.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for video conference management using a local electronic device connected to a server which is connected to remote electronic devices and which stores an Internet Protocol (IP) address of each of the local electronic device and the remote electronic device, the method comprising:
requesting the server for an IP address of each of the remote electronic devices;
receiving the IP address of each of the remote electronic devices from the server;
establishing connections between the local electronic device and each of the remote electronic devices according to the IP address of each of the remote electronic devices;
acquiring an image of a user of the local electronic device captured by a camera device of the local electronic device;
receiving images of remote users of the remote electronic devices from the remote electronic devices;
merging the acquired image and the received images into a first image for the user of the local electronic device and merging the acquired image and the received images into a second image for the remote users of the remote electronic devices; and
transmitting the second image to the remote electronic devices.

2. The method according to claim 1, wherein a resolution of the first image is more than a resolution of the second image.

3. The method according to claim 1, wherein the acquired image and the received images are merged into the first image by:
determining a number of the acquired image and the received images;
determining resolutions of the acquired image and the received images;
determining a maximum resolution among the determined resolutions;
creating a first two-dimensional array according to the determined number and the maximum resolution, each element of the first two-dimensional array can store an image having the maximum resolution; and
storing the acquired image and the received images in the first two-dimensional array, each of the acquired image and the received images can be stored as an element of the first two-dimensional array.

4. The method according to claim 1, wherein the acquired image and the received images are merged into the second image by:
determining a number of the acquired image and the received images;
setting a specified resolution according to the determined resolutions, the specified resolution is less than the maximum resolution;
creating a second two-dimensional array according to the determined number and the specified resolution, each element of the first two-dimensional array can store an image having the specified resolution;
compressing the acquired image into a compressed acquired image having the specified resolution and compressing each of the received images image into a compressed received image having the specified resolution; and
storing the compressed acquired image and the compressed received images in the second two-dimensional array, each of the compressed acquired image and the compressed received images being stored as an element of the second two-dimensional array.

5. The method according to claim 1, wherein the local electronic device identifies each of the remote electronic devices according to the received IP address of each of the remote electronic devices.

6. The method according to claim 1, wherein the connections are established between the local electronic device and each of the remote electronic devices via a Voice over Internet Protocol (VoIP).

7. A local electronic device, comprising:
a processor; and
a storage device that stores one or more programs, the local electronic device being connected to a server which is connected to remote electronic devices and which stores an Internet Protocol (IP) address of each of the local electronic device and the remote electronic device, when executed by the at least one processor, cause the at least one processor to:
request the server for an IP address of each of the remote electronic devices;
receive the IP address of each of the remote electronic devices from the server;
establish connections between the local electronic device and each of the remote electronic devices according to the IP address of each of the remote electronic devices;
acquire an image of a user of the local electronic device captured by a camera device of the local electronic device;
receive images of remote users of the remote electronic devices from the remote electronic devices;
merge the acquired image and the received images into a first image for the user of the local electronic device and merge the acquired image and the received images into a second image for the remote users of the remote electronic devices; and
transmit the second image to the remote electronic devices.

8. The local electronic device according to claim 7, a resolution of the first image is more than a resolution of the second image.

9. The local electronic device according to claim 7, wherein the acquired image and the received images are merged into the first image by:
determining a number of the acquired image and the received images;
determining resolutions of the acquired image and the received images;
determining a maximum resolution among the determined resolutions;
creating a first two-dimensional array according to the determined number and the maximum resolution, each element of the first two-dimensional array can store an image having the maximum resolution; and
storing the acquired image and the received images in the first two-dimensional array, each of the acquired image and the received images can be stored as an element of the first two-dimensional array.

10. The local electronic device according to claim 7, wherein the acquired image and the received images are merged into the second image by:
determining a number of the acquired image and the received images;
setting a specified resolution according to the determined resolutions, the specified resolution is less than the maximum resolution;
creating a second two-dimensional array according to the determined number and the specified resolution, each element of the first two-dimensional array can store an image having the specified resolution;
compressing the acquired image into a compressed acquired image having the specified resolution and compressing each of the received images image into a compressed received image having the specified resolution; and
storing the compressed acquired image and the compressed received images in the second two-dimensional array, each of the compressed acquired image and the compressed received images being stored as an element of the second two-dimensional array.

11. The local electronic device according to claim 7, wherein the local electronic device identifies each of the remote electronic devices according to the received IP address of each of the remote electronic devices.

12. The local electronic device according to claim 7, wherein the connections are established between the local electronic device and each of the remote electronic devices via a Voice over Internet Protocol (VoIP).

13. A non-transitory storage medium having stored thereon instructions that, when executed by a processor of a local electronic device, causes the processor to perform a method for video conference management, t the local electronic device being connected to a server which is connected to remote electronic devices and which stores an Internet Protocol (IP) address of each of the local electronic device and the remote electronic device, wherein the method comprises:
requesting the server for an IP address of each of the remote electronic devices;
receiving the IP address of each of the remote electronic devices from the server;
establishing connections between the local electronic device and each of the remote electronic devices according to the IP address of each of the remote electronic devices;
acquiring an image of a user of the local electronic device captured by a camera device of the local electronic device;
receiving images of remote users of the remote electronic devices from the remote electronic devices;
merging the acquired image and the received images into a first image for the user of the local electronic device and merging the acquired image and the received images into a second image for the remote users of the remote electronic devices; and
transmitting the second image to the remote electronic devices.

14. The non-transitory storage medium according to claim 13, wherein a resolution of the first image is more than a resolution of the second image.

15. The non-transitory storage medium according to claim 13, wherein the acquired image and the received images are merged into the first image by:
determining a number of the acquired image and the received images;
determining resolutions of the acquired image and the received images;
determining a maximum resolution among the determined resolutions;
creating a first two-dimensional array according to the determined number and the maximum resolution, each element of the first two-dimensional array can store an image having the maximum resolution; and
storing the acquired image and the received images in the first two-dimensional array, each of the acquired image and the received images can be stored as an element of the first two-dimensional array.

16. The non-transitory storage medium according to claim 13, wherein the acquired image and the received images are merged into the second image by:
determining a number of the acquired image and the received images;
setting a specified resolution according to the determined resolutions, the specified resolution is less than the maximum resolution;
creating a second two-dimensional array according to the determined number and the specified resolution, each element of the first two-dimensional array can store an image having the specified resolution;
compressing the acquired image into a compressed acquired image having the specified resolution and compressing each of the received images image into a compressed received image having the specified resolution; and
storing the compressed acquired image and the compressed received images in the second two-dimensional array, each of the compressed acquired image and the compressed received images being stored as an element of the second two-dimensional array.

17. The non-transitory storage medium according to claim 13, wherein the local electronic device identifies each of the remote electronic devices according to the received IP address of each of the remote electronic devices.

18. The non-transitory storage medium according to claim 13, wherein the connections are established between the local electronic device and each of the remote electronic devices via a Voice over Internet Protocol (VoIP).
